(19) United States
(12) Patent Application Publication
(10) Pub. No.: US 2014/0081803 A1
(43) Pub. Date: Mar. 20, 2014

(54) METHOD OF LOCATING POINT OF SALE OF A PRODUCT BY ITS FLAVOR

(71) Applicant: Roger CLAWSON, Rancho Santa Margarita, CA (US)

(72) Inventor: Roger CLAWSON, Rancho Santa Margarita, CA (US)

(21) Appl. No.: 13/622,569

(22) Filed: Sep. 19, 2012

(51) Int. Cl. G06Q 30/00; G01C 21/00

(52) U.S. Cl. 705/26.9

(57) ABSTRACT

The present invention provides a method comprising: receiving a flavor identifier for a desired product, which flavor identifier was entered into a wireless computer, such as a tablet computer or a Personal Digital Assistant (PDA) by a customer for said product, determining one or more physical locations of the desired product; receiving a signal identifying a current real-time physical location of the customer for said product; generating a set of one or more instructions describing a travel pathway from a starting physical location of the customer to one or more of the physical locations of the desired product; and generating an image, for use on a display, that depicts a travel pathway to one or more physical locations of said product. Furthermore, said invention provides a server comprising a processing module coupled to a memory, wherein the memory comprises a plurality of instructions executable by the processing module, which when executed, cause the processing module to perform the method of this invention. Finally, said invention provides a machine-readable medium having a plurality of instructions processable by a machine embodied therein, wherein said plurality of instructions, when processed by said machine causes said machine to perform the method of this invention.

### BACKGROUND OF THE INVENTION

This invention provides a method for identifying the establishment closest to the customer or to the customer's preferred location which sells dessert(s) of a particular flavor (e.g. pumpkin pie flavor). This invention also provides an application (commonly known as an “app”) for mobile device operating systems which, at the customer's request, will search for and identify the establishment closest to the customer or to the customer's preferred location which sells dessert(s) of a particular flavor according to the customer's chosen search parameters inputted through the app's customer interface (“UI”). With respect to the location(s) the app finds and presents to the customer, the app may also provide the customer with correlated map and direction information. The information which the app searches, analyzes, organizes, and provides to the customer may come, from, among other sources, the seller's proprietary database, business-to-business relationships, the mobile device's GPS technology, and the customer's preferred map app already installed on the customer's mobile device(s).

The app is designed, adaptable, and updatable for all mobile operating systems, including but not limited to the mobile operating systems used in mobile devices, i.e. smartphones, tablets, etc., marketed by Apple, Android (Google), Windows Mobile (Microsoft), and Kindle (Amazon).

The app searches for an identified flavor (e.g. pumpkin pie flavor) and not a particular dessert (e.g. cheesecake) or dessert provider (e.g. Cheesecake Factory). The app's customer interface, through a process of touchable prompts on a mobile device screen, enables the customer to locate the desired flavor(s) and corresponding retailer(s) within a defined perimeter of the customer.

### BRIEF SUMMARY OF THE INVENTION

The present invention is especially useful for finding a conveniently located establishment that sells a desired dessert, e.g. a yogurt dessert, by identifying the flavor thereof. As such, the present invention provides a method comprising: receiving a flavor identifier for a desired product, which flavor identifier was entered into a wireless computer, such as a tablet computer or a Personal Digital Assistant (PDA) by a customer for said product; determining one or more physical locations of the desired product; receiving a signal identifying a current real-time physical location of the customer for said product; generating a set of one or more instructions describing a travel pathway from a starting physical location of the customer to one or more of the physical locations of the desired product; and generating an image, for use on a display, that depicts a travel pathway to one or more physical locations of said product. The method of this invention may be carried out with the assistance of an app which is configured for receiving said flavor identifier, determining one or more physical locations of the desired product; receiving a signal identifying a current real-time physical location of the customer for said product; generating a set of one or more instructions describing a travel pathway from a starting physical location of the customer to one or more of the physical locations of the desired product; and generating an image, for use on a display, that depicts a travel pathway to one or more physical locations of said product.

### BRIEF DESCRIPTION OF THE DRAWING FIGURES

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1 shows the first screen (hereinafter referred to as “Screen 1”) that is obtained when the customer that desires to have a yogurt dessert accesses the Golden Spoon website with a PDA;

FIG. 2 shows an alternate arrangement of Screen 1, wherein the icons for the same links that are shown in FIG. 1 are arranged in a vertical order;

FIG. 3 shows the screen which is downloaded when the customer clicks on the first icon which downloads a map showing the Golden Spoon stores in the vicinity;

FIG. 3a shows a variation of FIG. 3 wherein map shows a greater geographic area wherein golden. Spoon stores are located;

FIG. 4 shows an alternate of FIG. 3, wherein other flavors are advertised;

FIG. 5 shows an alternate screen that may be accessed by the flavor finder link or, as shown here by clicking on the icon labeled as CHOCOLATE in FIG. 3;

FIG. 6 is an example of the link accessible by clicking on the second icon on the screen shown in FIG. 1. As shown, the screen shown in this FIG. 6 enables the person to communicate with Facebook “friends” about his favorite yogurt flavors and/or recipes for preparing other desserts from yogurt;

FIG. 7 shows a screen w is an alternate embodiment of the screen of FIG. 6, serving the same purpose;

FIG. 8 shows a screen which is an alternate or successor to the screens shown in FIGS. 3 and 4. The screen in FIG. 8 provides a method for searching for the nearest location of a Golden Spoon store or a Golden Spoon store in a particular area, as defined by the area zip code, by entering the zip code in the zip code-labeled box and clicking on the search box;

FIG. 8a shows a screen which is also a successor to the screens shown in FIGS. 3 and 4 or an alternate to the screen shown in FIG. 8 wherein the dessert found by the selected flavor identifier is further limited by the other characteristics such as “non-fat”, “gluten-free”, etc.;

FIG. 9 is also provides a screen which is an alternate or successor to the screens shown in FIGS. 3 and 4. The screen in FIG. 9 provides a method for searching for the nearest location of a Golden Spoon store or a Golden Spoon store in a particular area, by clicking on the appropriate box, i.e. the box labeled “Find Nearest Store” or entering the zip code in the box labeled “Search By Zip Code”, respectively;

In reference to the discussion of the “Join the G-Club” icon on the initial screen, shown in FIG. 1, above;

FIG. 10 is an example of the information that can be shared by communication between the person and Golden Spoon. This screen enables the person to obtain a free yogurt on his birthday;

FIG. 11 is an alternate embodiment of FIG. 10, serving the same purpose.

### DETAILED DESCRIPTION OF THE INVENTION

For the purpose of the present invention, flavor means a taste, especially the distinctive taste of something as it is experienced in the mouth.

Moreover, flavor is a substance or extract that provides a particular taste. Preferred flavors, especially for the preferred yogurt desserts, include chocolate, cappuccino, toffee mango tart, strawberry banana, cake batter, vanilla, pumpkin pie, etc.

A mobile operating system (mobile OS) is the operating system that controls a smartphone, tablet, PDA, or other mobile device. Modern mobile operating systems combine the features of a personal computer operating system with touchscreen, cellular, Bluetooth, Wi-Fi, UPS mobile navigation, camera, video camera, speech recognition, voice recorder, music player, near field communication, personal digital assistant (PDA), and other features.

In information technology, an application, which is also referred to as an app, is a computer program designed to help people perform an activity. An application thus differs from an operating system (which runs a computer), a utility (which performs maintenance or general-purpose chores), and a programming tools (with which computer programs are created). Depending on the activity for which it was designed, an application can manipulate text, numbers, graphics, or a combination of these elements. Some application packages offer considerable computing power by focusing on a single task, such as word processing; others, called integrated software, offer somewhat less power but include several applications. User-written software tailors systems to meet the user's specific needs. User-written software includes spreadsheet templates, word processor macros, scientific simulations, graphics, and animation scripts.

The delineation between system software such as operating systems and application software is not exact, however, and is occasionally the object of controversy. For example, one of the key questions in the United States v. Microsoft antitrust trial was whether

Microsoft's Internet Explorer web browser was part of its Windows operating system or a separable piece of application software. As another example, the GNU/Linux naming controversy is, in part, due to disagreement about the relationship between the Linux kernel and the operating systems built over this kernel. In some types of embedded systems, the application software and the operating system software may be indistinguishable to the user, as in the case of software used to control a VCR, DVD player or microwave oven. The above definitions may exclude some applications that may exist on some computers in large organizations.

With the spread of smartphones and tablet computers around 2010, the short form app was in some popular news accounts restricted to mobile apps.

In 2006, it was reported that 64 million smartphones were sold even though Android, iOS, Windows Phone, and Bada did not yet exist. Today, nearly 10 times as many smartphones are sold and the top mobile operating systems marketed as “smartphones” are Android, Symbian, Apple iOS, RIM BlackBerry, MeeGo, Windows Phone, and Bada.

### DETAILED DESCRIPTION OF THE PREFERRED EMBODIMENT

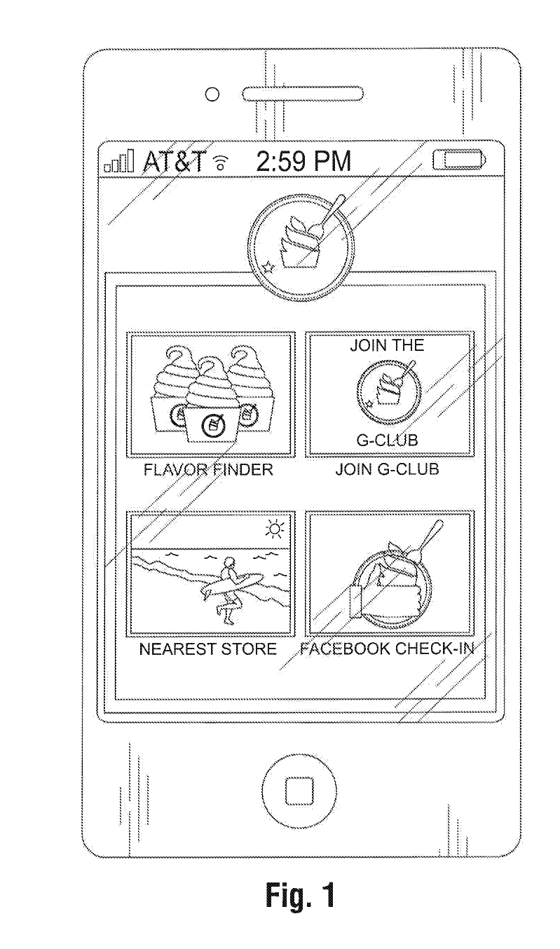

The practice of the present invention is shown by reference to FIGS. 1 through 11, which exemplifies a purchase of a yogurt product from Golden Spoon a seller or retailer of yogurt dessert products, which are offered in many flavors. (It is to be understood that the present invention is not limited to the Golden Spoon and/or yogurt desserts. Instead the invention relates to the purchase and selling of any dessert that can be characterized and/or identified by a particular flavor, i.e. the present invention provides a method of locating, purchasing and/or selling any dessert product.

In a preferred embodiment of the invention, FIG. 1 shows the first screen that is obtained when the customer that desires to have a yogurt accesses the Golden Spoon website with a PDA. His screen provides a first icon which is a link to the Golden Spoon's proprietary data base which data base in combination with the customer's own GPS informs him of the location of the nearest Golden Stones store. (This first screen also provides a second icon which links to Facebook (or other social networking sites.) This screen also has a third icon which links to a screen which would enable the person to join the G Club, wherein membership in said club could be utilized to provide a method for the customer and the Golden Spoon to engage in future communications, such as criticisms, announcements of new products, reward programs, etc. As shown, the first screen may also advertise new products such as the new red velvet-flavored product being introduced. Finally, the first screen can link to another proprietary screen through a fourth icon (flavor finder) which lists the flavors of yogurt products offered by Golden Spoon.

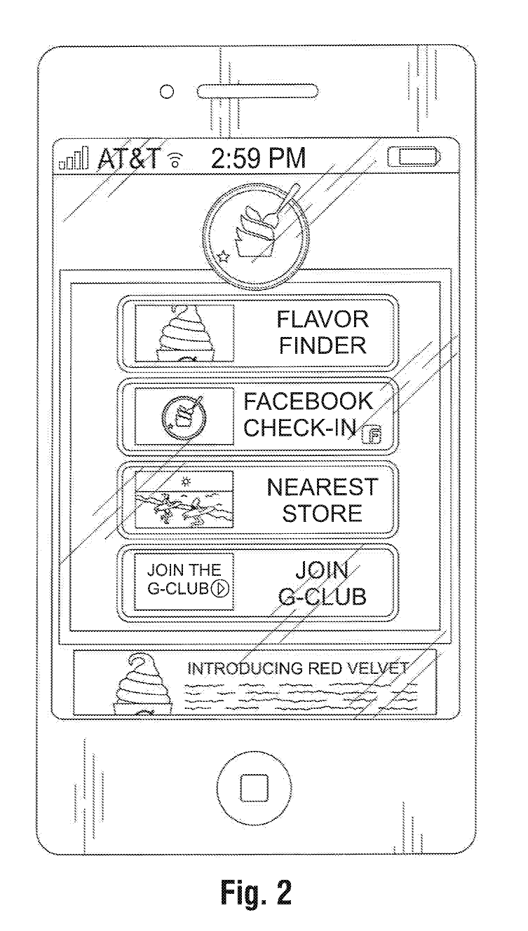

FIG. 2 shows an alternate arrangement of Screen 1, wherein the icons for the same links that are shown in FIG. 1 are arranged in a vertical order.

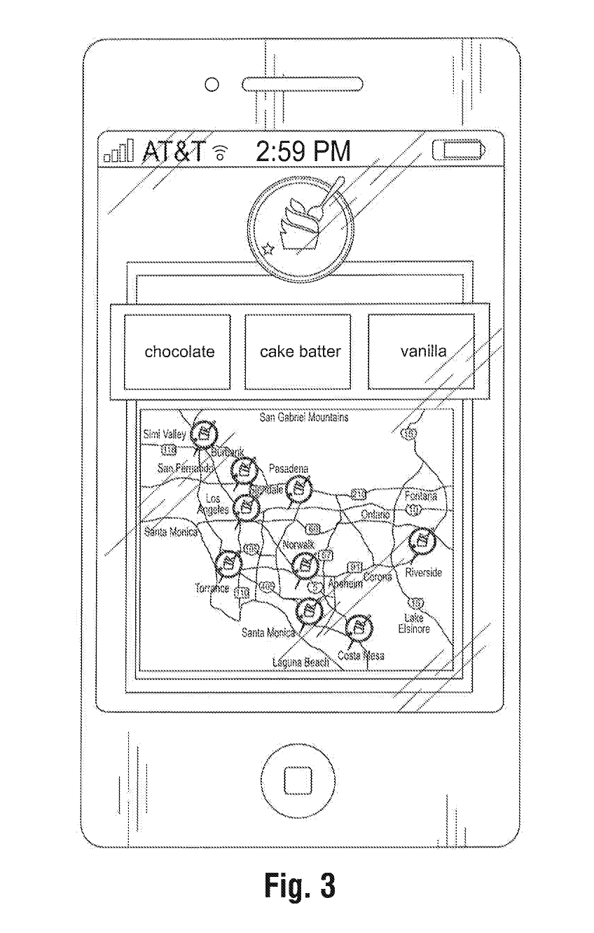

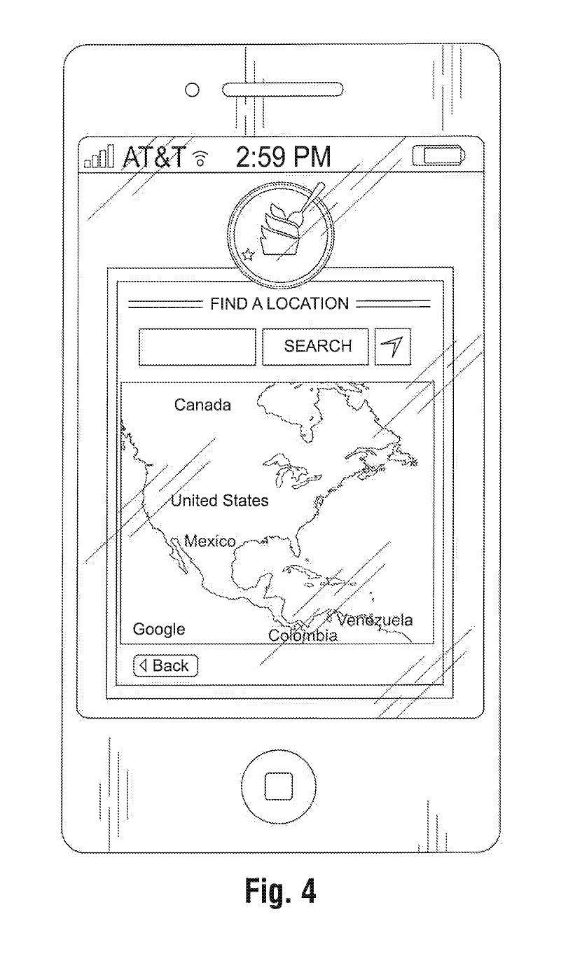

FIG. 3 shows the screen which is provided when the person clicks on the first icon wherein there is provided a map showing the Golden Spoon stores in the vicinity. (Of course, this map may be varied by modifying the perimeters according to the desires of the person.) As shown, this screen can also advertise a selection of one or more—here three—flavors available for products, including yogurt products available at any of the Golden Spoon stores. Preferably, said products are advertised by providing icons which are links to other screens whereby additional information about the specific flavor identified by the icon

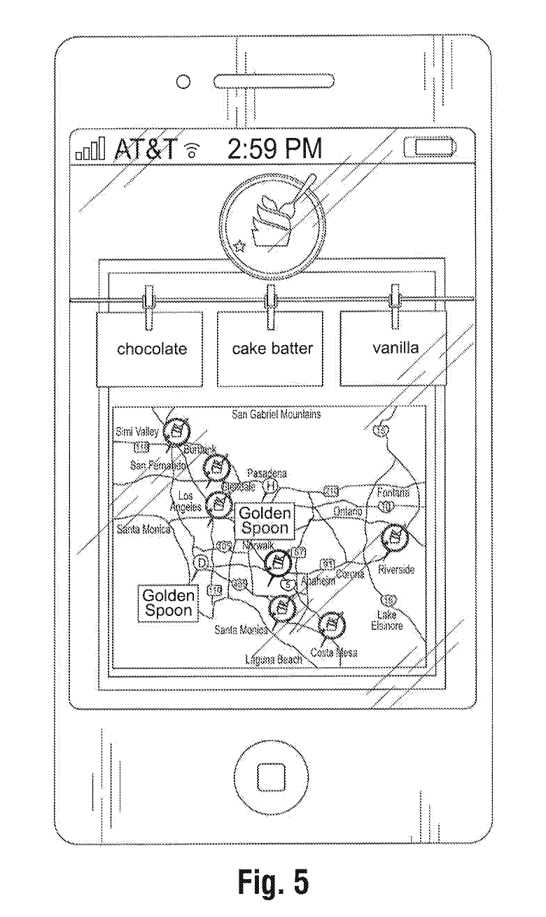

FIG. 4 shows an alternate of FIG. 3, wherein other flavors are advertised.

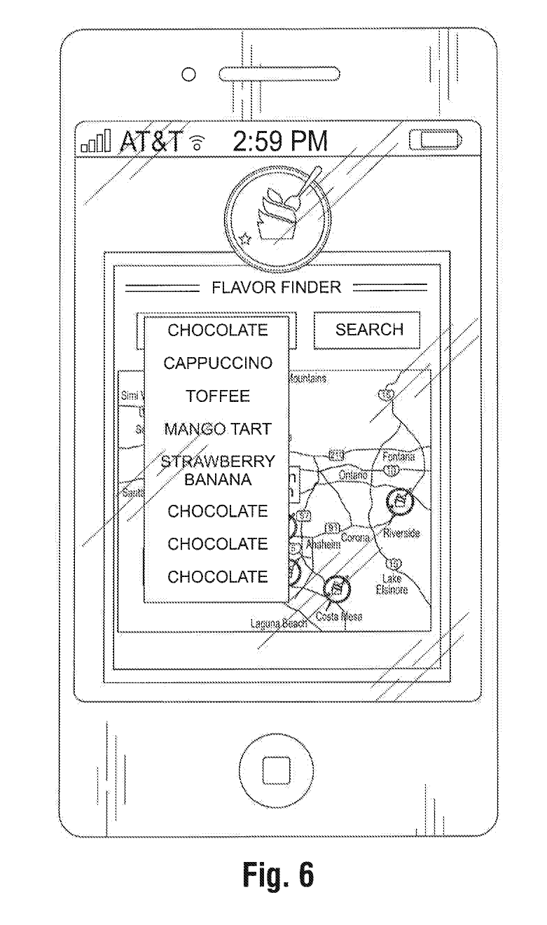

FIG. 5 shows an alternate screen that may be accessed by the flavor finder link. Or as shown here by clicking on the icon labeled as CHOCOLATE in FIG. 3. As noted, the screen shown in FIG. 5 enables the person to access a search function which provides a drop down menu which can be used to alphabetically search for all of the flavors available from the seller, i.e. Golden Spoon.

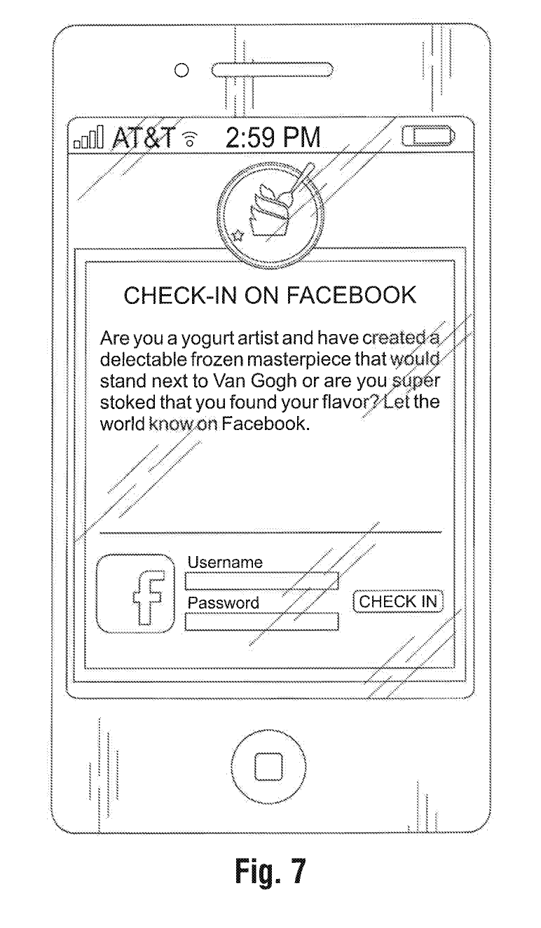

FIG. 6 is an example of the link accessible by clicking on the second icon on the screen shown in FIG. 1. As shown, the screen shown in this FIG. 6 enables the person to communicate with Facebook “friends” about his favorite yogurt flavors and/or recipes for preparing other desserts from yogurt.

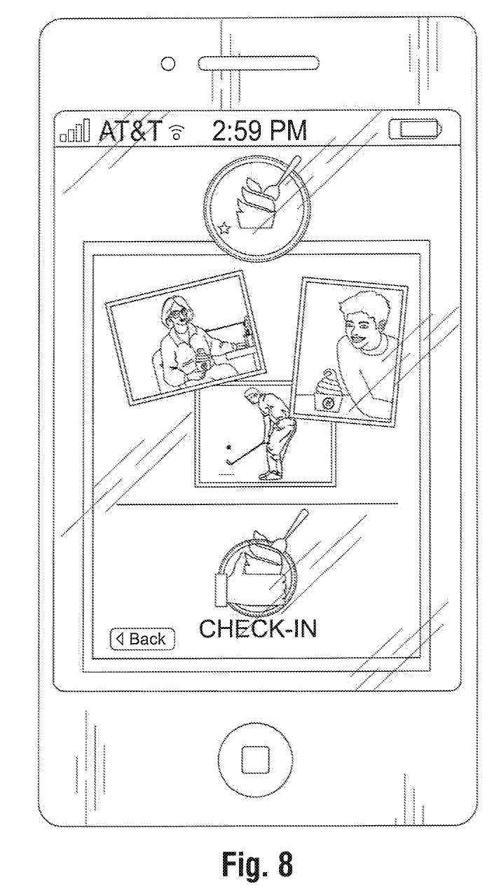

FIG. 7 shows a screen which is an alternate embodiment of the screen of FIG. 6, serving the same purpose.

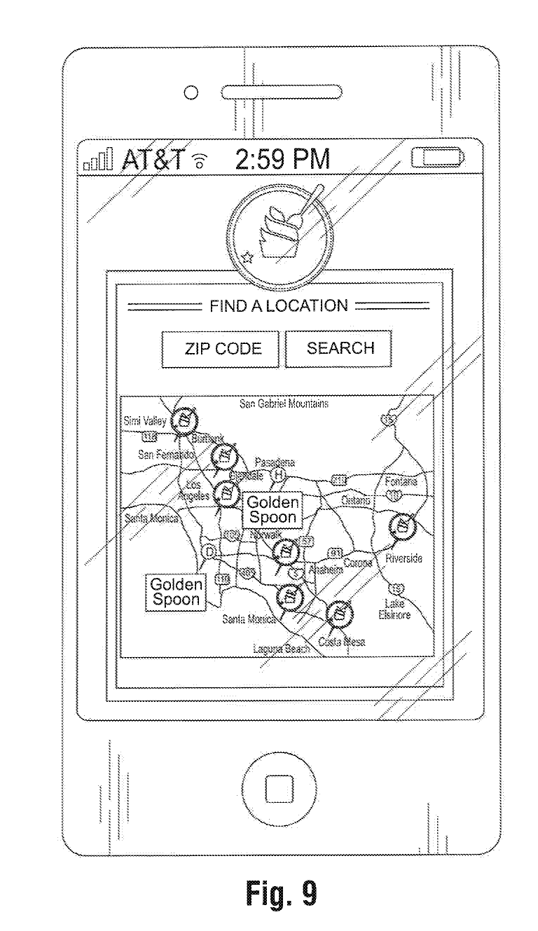

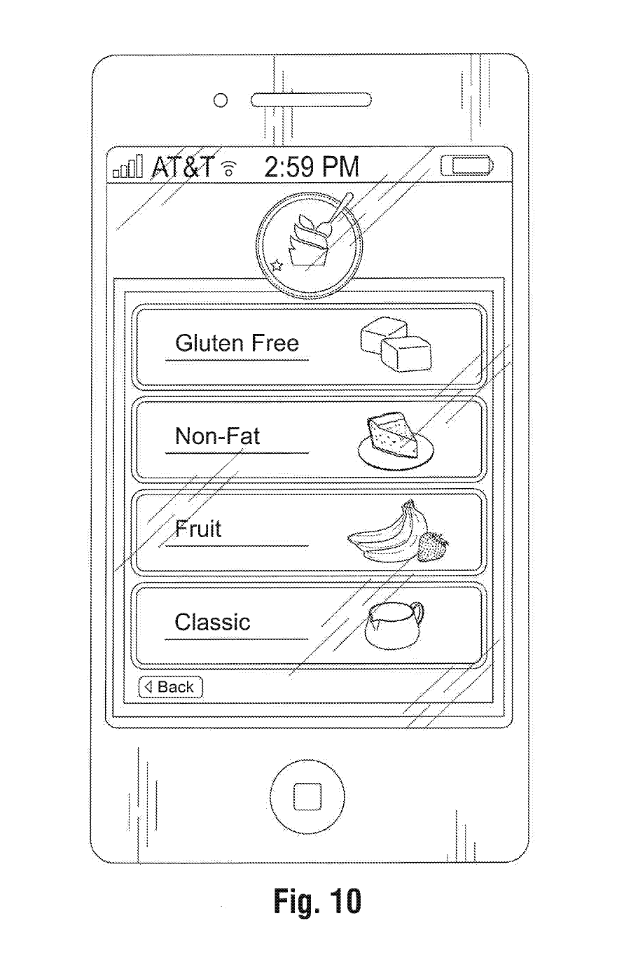

FIG. 8 provides a screen which is an alternate or successor to the screens shown in FIGS. 3 and 4. The screen. in FIG. 8 provides a method for searching for the nearest location of a Golden Spoon store or a Golden Spoon store in a particular area, as defined by the area zip code, by entering the zip code in the zip code-labeled box and clicking on the search box.

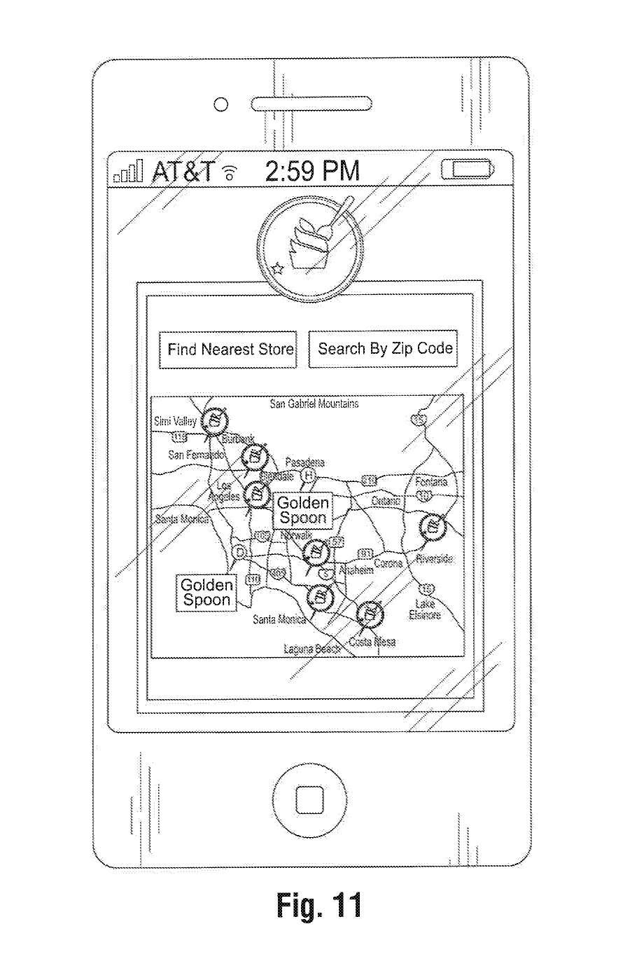

FIG. 9 is also provides a screen which is an alternate or successor to the screens shown in FIGS. 3 and 4. The screen in FIG. 9 provides a method for searching for the nearest location of a Golden Spoon store or a Golden Spoon store in a particular area, by clicking on the appropriate box, i.e. the box labeled “Find Nearest Store” or entering the zip code in the box labeled “Search By Zip Code”, respectively.

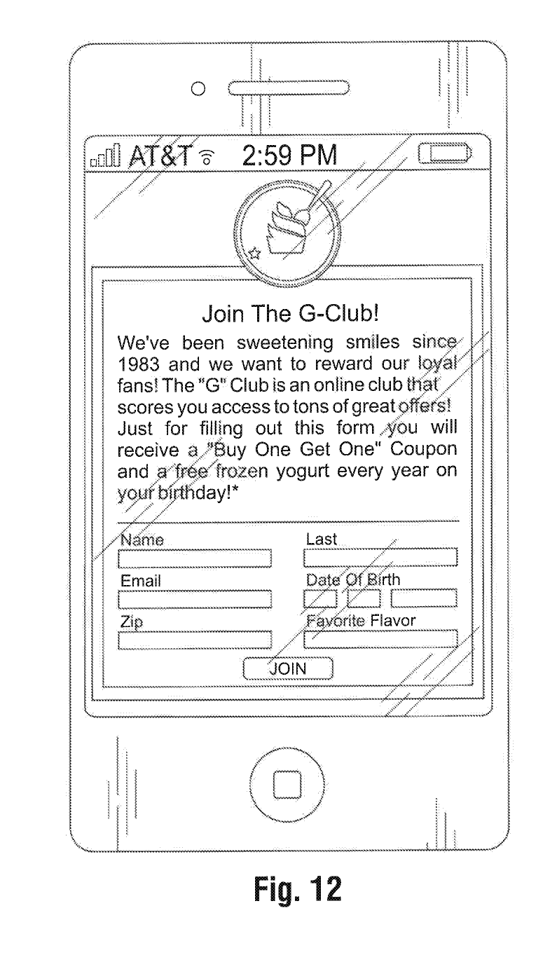

In reference to the discussion of the third icon. on the initial screen, shown in FIG. 1, above, FIG. 10 is an example of the information that can be shared by communication. between the person and Golden Spoon. This screen enables the person to obtain a free yogurt on his birthday.

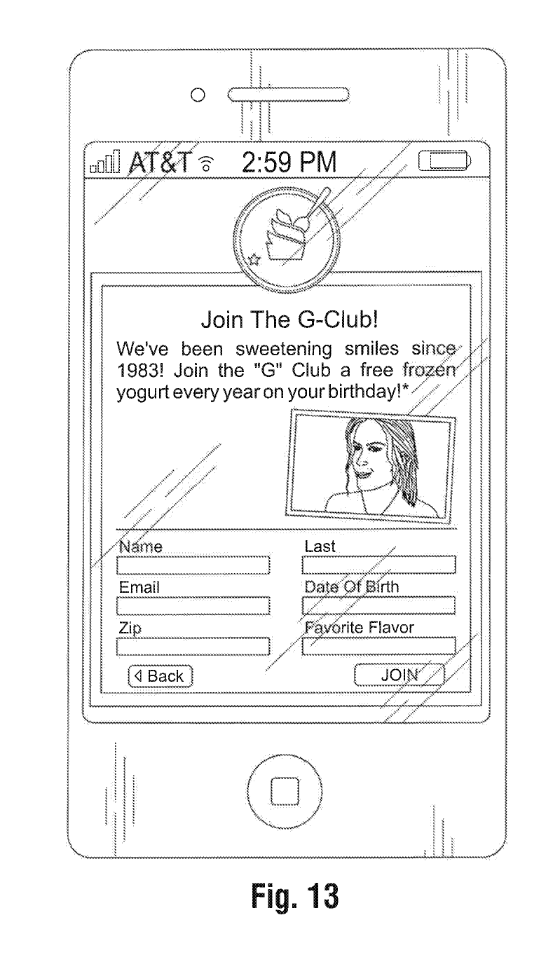

FIG. 11 is an alternate embodiment of FIG. 10, serving the same purpose.

While the invention has been particularly shown and described with reference to a preferred embodiment, it will be understood by those skilled in the art that various changes in form and detail may be made therein without departing from the spirit and scope of the invention.

What is claimed is:

1. A method comprising: receiving a flavor identifier for a desired product, which flavor identifier was entered into a wireless device, such as a tablet computer or a Personal Digital Assistant (PDA) by a customer for said product; determining one or more physical locations of the desired product; receiving a signal identifying a current real-time physical location of the customer for said product; generating a set of one or more instructions describing a travel pathway from a starting physical location of the customer to one or more of the physical locations of the desired product; and generating an image, for use on a display, that depicts a travel pathway to one or more physical locations of said product.

2. The method of claim 1, further comprising: transmitting the image that depicts a travel pathway to one or more physical locations of said product to a wireless device.

3. The method of claim 1, further comprising, in response to a determination that the customer is not at a facility in which the desired product is located, generating a map to a nearest facility that has the desired product in stock.

4. The method of claim 1, further comprising: receiving a real-time location of wireless device used by the customer via a Global Positioning System (GPS) receiver in the wireless device.

5. The method of claim 1, wherein said wireless device is a smart phone.

6. A server comprising a processing module coupled to a memory, wherein the memory comprises a plurality of instructions executable by the processing module, which when executed, cause the processing module to perform a method comprising: receiving a flavor identifier for a desired product, which flavor identifier was entered into a wireless computer, such as a tablet computer or a Personal Digital Assistant (PDA) by a customer for said product; determining one or more physical locations of the desired product; receiving a signal identifying a current real-time physical location of the customer for said product; generating a set of one or more instructions describing a travel pathway from a starting physical location of the customer to one or more of the physical locations of the desired product; and generating an image, for use on a display, that depicts a travel pathway to one or more physical locations of said product.

7. The server of claim 6, wherein the instructions are further configured for: transmitting an image that depicts a travel pathway to one or more physical locations of said product to a wireless device.

8. The server of claim 6, wherein in response to a determination that the customer is not at an establishment in which the desired product is located, the instructions are further configured for generating a map to a nearest establishment that has the desired product in stock.

9. The service of claim 6 wherein said processing module is a smartphone.

10. The server of claim 6, wherein the instructions are further configured for receiving a real-time location of wireless device used by the customer via a Global Positioning System (GPS) receiver in the wireless device.

11. A machine-readable medium having a plurality of instructions processable by a machine embodied therein, Wherein said plurality of instructions, when processed by said machine, causes said machine to perform a method comprising: receiving a flavor identifier for a desired product; determining a physical location of the desired product; receiving a signal identifying a current real-time physical location of a customer; generating a set of one or more instructions describing a travel pathway from a starting physical location of the customer to the final physical location of the desired product; and generating an image, for use on a display that depicts a travel pathway to one or more physical locations of said product.

12. The medium of claim 11, wherein the instructions are further configured for transmitting the image that depicts a travel pathway to one or more physical locations of said product to a wireless device.

13. The medium of claim 11, wherein, in response to a determination that the customer is not at an establishment in which the desired product is located, the instructions are further configured for generating a map to a nearest establishment that has the desired product in stock.

14. The medium of claim 11, wherein the instructions are further configured for receiving a real-time location, of wireless device used by the customer via a Global Positioning System (GPS) receiver in the wireless device.
